(19) United States
(12) Patent Application Publication
(10) Pub. No.: US 2008/0071730 A1
(43) Pub. Date: Mar. 20, 2008

(54) Method and Apparatus to Calculate Relational Database Derived Fields During Data Modification

(76) Inventors: Roland Barcia, Leonia, NJ (US); Kulvir S. Bhogal, Fort Worth, TX (US); Robert R. Peterson, Round Rock, TX (US); Alexandre Polozoff, Bloomington, IL (US)

Correspondence Address: IBM CORP. (RALEIGH SOFTWARE GROUP);c/o Rudolf O Siegesmund Gordon & Rees, LLP, 2100 Ross Avenue, Suite 2800, DALLAS, TX, 75201, US

(21) Appl. No.: 11/531,950

(22) Filed: Sep. 14, 2006

(51) Int. Cl. G06F 17/30

(52) U.S. Cl. 707/2

(57) ABSTRACT

The “Derived Field Calculator” calculates and updates derived fields within a relational database when objects in the database are modified rather than when the database is queried. The derived fields are maintained in the relational database independently from the applications accessing or modifying the database. Independence from external applications is achieved by adding the DFC to existing components of a relational database management system (“RDBMS”) so that the RDBMS can update the derived fields in the relational database without running Object Relational Mapping (ORM) tools, special stored procedures or triggers, or external applications.

### FIELD OF THE INVENTION

The present invention relates generally to database management and data structures, and relates specifically to defining derived fields in a relational database and to calculating the value of the derived fields during data modification.

### BACKGROUND OF THE INVENTION

Relational database management systems (“RDBMS”) often create relational databases as SQL (Structured Query Language) databases. SQL is a ANSI/ISO standard computer language used to create, modify, retrieve, and manipulate data from relational database management systems. RDBMS also use computer language subsets of SQL's instruction set known as DDL (Data Definition Language) and DML (Data Manipulation Language).

DDL provides commands for defining a data model such as “CREATE,” “DROP,” and “ALTER.” The DDL “CREATE” command is used to create a table and to define the table fields, referred to columns, in a SQL database. Arguments in the CREATE command define the parameters of each column in the table. An example CREATE command follows:

CREATE TABLE CUSTOMER_USER.ORDER (ORDER_ID
INTEGER NOT NULL, CUSTOMER_ID INTEGER NOT NULL,
STATUS VARCHAR (250), PRETAX_TOTAL DOUBLE, TAX
DOUBLE, TOTAL DOUBLE);

FIG. 1A depicts a table created by the above command. The DDL command “ALTER” modifies objects in the database, and the DDL command “DROP” removes a portion of or all of a database.

DML provides commands for manipulating data in a SQL database. DML commands include “INSERT,” “MODIFY,” “UPDATE,” and “DELETE.” An example INSERT command follows:

INSERT INTO CUSTOMER_USER.ORDER (ORDER_ID,
CUSTOMER_ID, STATUS, PRETAX_TOTAL, TAX) VALUES
(123, 223, ‘OPEN’, 100.00, 6.00);

Referring to FIG. 1A and FIG. 1B, the above INSERT command places values into the table of depicted in FIG. 1A, and FIG. 1B depicts the resulting table with the inserted values. The TOTAL column will show the calculated sum of PRETAX_TOTAL and TAX. The TOTAL column is a “derived field” not supported by the prior art relational database.

A “derived field” in a data model, such as a table or database, is a field with a calculated value based on elements in other data fields called “makeup fields”. For example, FIG. 1C depicts a derived field using a standard spreadsheet with columns A, B, and C. Columns A and B are defined as numerical data fields, a and b, respectively. Column C is defined as a mathematical expression calculating the sum of a and b. Columns A and B are makeup fields, and column C is a derived field. When a=3 and b=5, the spreadsheet calculates that c=8. Whenever the value of a or b changes, c is automatically recalculated.

RDBMS, such as those using the SQL standard, usually do not provide native support for derived fields in relational databases. Generally, the task of calculating derived fields in a relational database is delegated to a separate application interacting with the database. One known technique of handling derived fields uses an Object Relational Mapping (ORM) tool. The ORM tool maps derived fields in the relational database to a separate data model capable of calculating derived fields. During the process of querying or populating objects in the relational database, the derived field is calculated in the separate data model. The calculated value of the derived field may be used by the application without being inserted into the relational database.

ORM techniques have drawbacks. First, recalculating the derived field using an external application for every query to the relational database consumes time and computer resources. Web applications, for example, may have high query rates causing frequent recalculations. Frequent recalculations decrease the query response time and increase the resources needed to support the relational database. Second, the derived fields are not represented or maintained within the relational database. The accuracy of the derived value in the relational database is dependant on the separate application working properly and updating the values for the derived fields promptly in response to any changes in the makeup fields of the relational database. Further, all applications accessing the relational database must be able to interact directly with the ORM tool to obtain the correct calculated values for the derived fields.

Therefore, a need exists for an integrated component of a RDBMS that updates the derived fields in response to any data modification of the corresponding makeup fields in the relational database without the use of an ORM.

### SUMMARY OF THE INVENTION

The Derived Field Calculator (DFC) integrates with an existing relational database management system (RDBMS) to update derived fields in response to any data modification of the corresponding makeup fields in the relational database of the RDBMS without the use of an ORM, additional stored procedures, or external applications. When objects in the relational database are modified, the DFC immediately calculates and updates derived fields within the relational database, rather than at the time when the database is queried. The derived fields are maintained in the relational database independently from the applications accessing or modifying the database. Independence from external applications is achieved by adding the DFC to existing components of the RDBMS so that the RDBMS can operate without an ORM.

First, the DFC employs a “DERIVE” column datatype in the DDL “CREATE” command. An expression referencing other columns in the CREATE command follows the DERIVE column datatype. Next, the DFC identifies all derived fields in the relational database and recreates the fields, with the expression, in a “derived fields table” in the database's metadata. The DFC identifies all makeup fields in the relational database and recreates the name of the fields without a value in a “makeup fields table” in the database's metadata. Finally, the DFC calculates the derived fields in response to DML commands. When a DML command runs, DFC checks the manipulated fields in the command against the metadata tables. The DFC prohibits direct updates to derived fields. The DFC takes changes to makeup fields and calculates the corresponding derived field. The DFC transforms the DML statement to include the updated derived field and executes the DML statement to update the relational database.

### BRIEF DESCRIPTION OF DRAWINGS

The novel features believed characteristic of the invention are set forth in the appended claims. The invention itself, however, as well as a preferred mode of use, further objectives and advantages thereof, will be understood best by reference to the following detailed description of an illustrative embodiment when read in conjunction with the accompanying drawings, wherein:

FIG. 1A is an exemplary relational database table;

FIG. 1B is an exemplary populated relational database table;

FIG. 1C. is an exemplary data model from a spreadsheet;

FIG. 2. is an exemplary computer network;

FIG. 3. describes programs and files in a memory on a computer;

FIG. 4A. is an exemplary relational database table;

FIG. 4B. is an exemplary populated relational database table;

FIG. 5. is a flowchart of a Definition Component; and

FIG. 6. is a flowchart of a Manipulation Component.

### DETAILED DESCRIPTION OF THE PREFERRED EMBODIMENT

The principles of the present invention are applicable to a variety of computer hardware and software configurations. The term “computer hardware” or “hardware,” as used herein, refers to any machine or apparatus that is capable of accepting, performing logic operations on, storing, or displaying data, and includes without limitation processors and memory. The term “computer software” or “software,” refers to any set of instructions operable to cause computer hardware to perform an operation. A “computer,” as that term is used herein, includes without limitation any useful combination of hardware and software, and a “computer program” or “program” includes without limitation any software operable to cause computer hardware to accept, perform logic operations on, store, or display data. A computer program may, and often is, comprised of a plurality of smaller programming units, including without limitation subroutines, modules, functions, methods, and procedures. Thus, the functions of the present invention may be distributed among a plurality of computers and computer programs. The invention is described best, though, as a single computer program that configures and enables one or more general-purpose computers to implement the novel aspects of the invention. For illustrative purposes, the inventive computer program will be referred to as the “Derived Field Calculator” (DFC).

Additionally, the DFC is described below with reference to an exemplary network of hardware devices, as depicted in FIG. 2. A “network” comprises any number of hardware devices coupled to and in communication with each other through a communications medium, such as the Internet. A “communications medium” includes without limitation any physical, optical, electromagnetic, or other medium through which hardware or software can transmit data. For descriptive purposes, exemplary network 100 has only a limited number of nodes, including workstation computer 105, workstation computer 110, server computer 115, and persistent storage 120. Network connection 125 comprises all hardware, software, and communications media necessary to enable communication between network nodes 105-120. Unless otherwise indicated in context below, all network nodes use publicly available protocols or messaging services to communicate with each other through network connection 125.

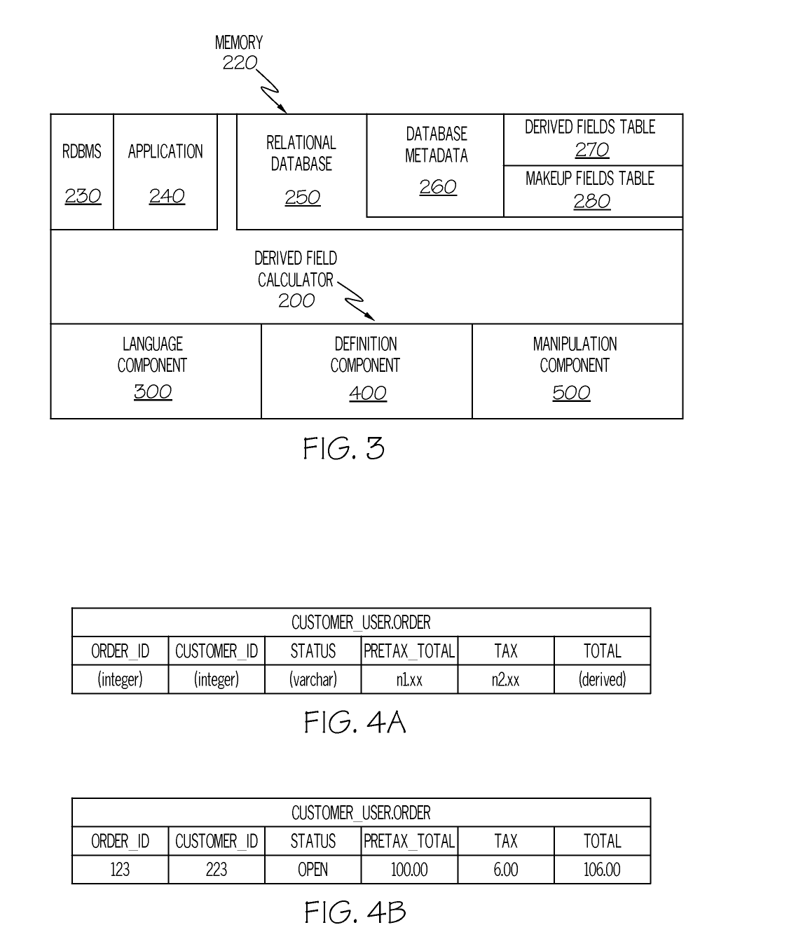

DFC 200 typically is stored in a memory, represented schematically as memory 220 in FIG. 3. The term “memory,” as used herein, includes without limitation any volatile or persistent medium, such as an electrical circuit, magnetic disk, or optical disk, in which a computer can store data or software for any duration. A single memory may encompass and be distributed across a plurality of media. Further DFC 200 may reside in more than one memory distributed across different computers, servers, logical partitions or other hardware devices. The elements depicted in memory 220 may be located in or distributed across separate memories in any combination, and DFC 200 may be adapted to identify, locate and access any of the elements and coordinate actions, if any, by the distributed elements. Thus, FIG. 3. is included merely as a descriptive expedient and does not necessarily reflect any particular physical embodiment of memory 220. As depicted in FIG. 3, memory 220 may include additional data and programs. Although shown as a separate set of components in FIG. 3, a preferred embodiment of DFC 200 is fully integrated with a relational database management system (“RDBMS”), shown here as RDBMS 230. Of particular import to DFC 200, memory 220 may include application 240 and relational database 250, with which DFC 200 interacts. Application 240 employs SQL commands to interact with relational database 250. Relational database 250 contains metadata, shown here as database metadata 260. Derived fields table 270 and makeup fields table 280 are part of database metadata 260. DFC 200 has language component 300, definition component 400 and manipulation component 500.

Language component adds a new “DERIVE” column datatype for the DDL “CREATE” command. The DERIVE column datatype is followed by an expression referencing other columns in the CREATE command. The DERIVE column field is referred to as the “derived field.” The column fields referenced by the DERIVE column's expression are “makeup fields.” The DERIVE column datatype can also be used with other DDL commands such as “ALTER.” An example of the modified CREATE command with the DERIVE datatype follows:

CREATE TABLE CUSTOMER_USER.ORDER (ORDER_ID
INTEGER NOT NULL, CUSTOMER_ID INTEGER NOT NULL,
STATUS VARCHAR (250), PRETAX_TOTAL DOUBLE, TAX
DOUBLE, TOTAL DERIVED [PRETAX_TOTAL + TAX]);

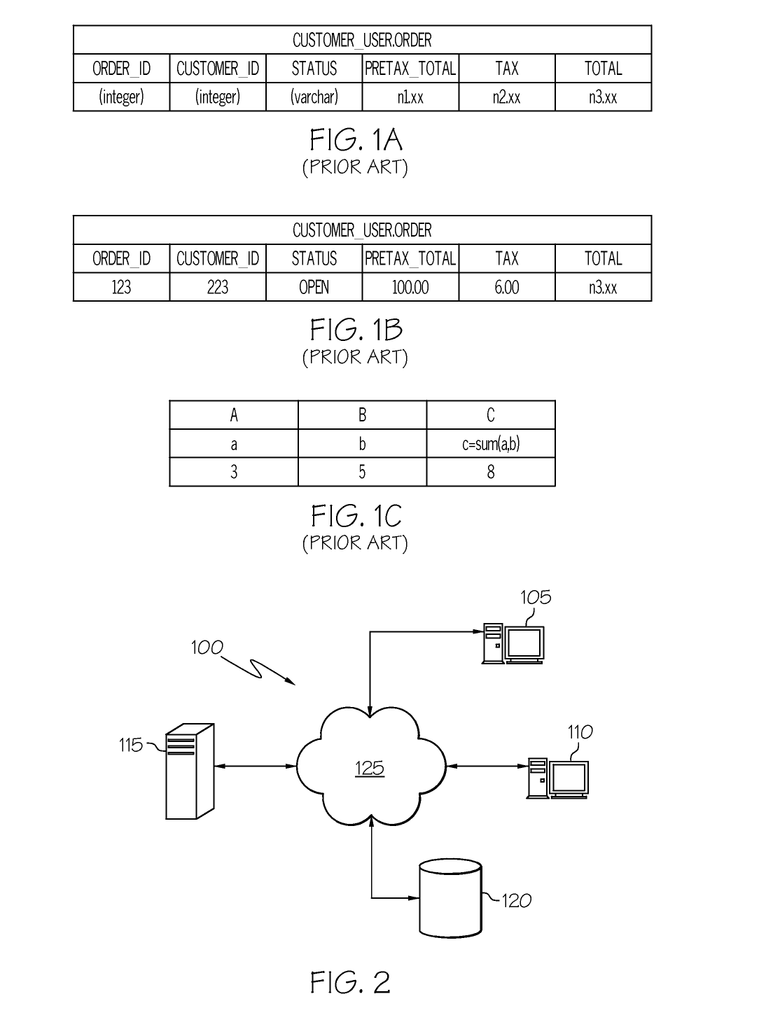

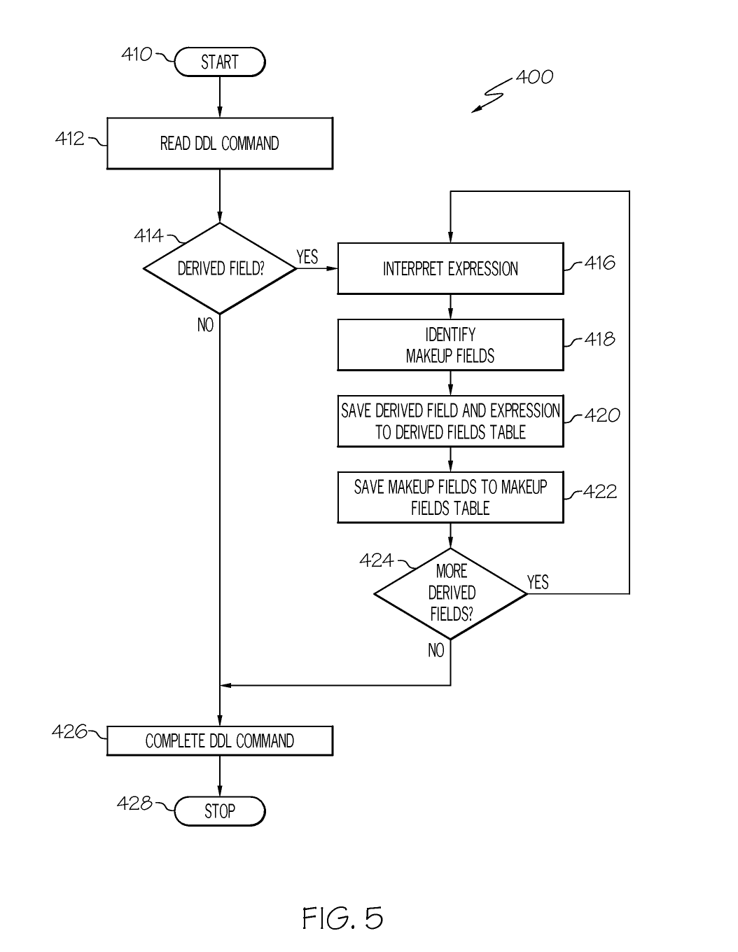

The above command, using the steps shown in FIG. 5, creates the table in FIG. 4A. FIG. 4A is similar to the table in FIG. 1A, but indicates a derived datatype for the TOTAL column. With DFC 200, the following INSERT command places an entry in the table as shown in FIG. 4B:

INSERT INTO CUSTOMER_USER.ORDER (ORDER_ID,
CUSTOMER_ID, STATUS, PRETAX_TOTAL, TAX)
VALUES (123, 223, ‘OPEN’, 100.00, 6.00);

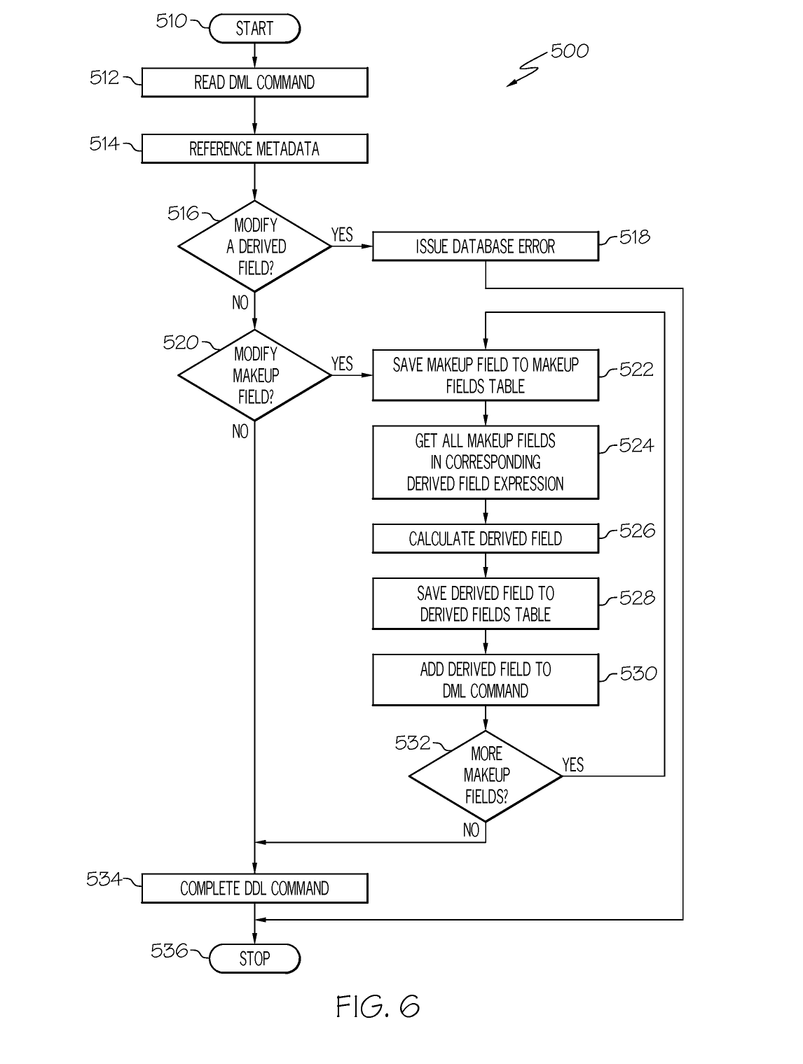

### The above command modifies the table just as in FIG. 1B., but DFC 200 calculates the derived field in the TOTAL column, as shown in FIG. 6.

FIG. 5 shows the steps taken by definition component 400 when executing a DDL command such as CREATE or ALTER. Whenever a DDL command is submitted manually or by an application such as application 240, definition component 400 starts (410) and reads the DDL command (412). If there are any derived fields in the DDL command (414), definition component 400 interprets the derived field expression (416) and identifies the makeup fields used by the expression (418). Definition component 400 saves the derived field and the expression in derived fields table 270 in database metadata 260 (420). For example, a row in derived fields table 270 is created with the command:

INSERT INTO DERIVED_FIELDS VALUES
(1, ‘CUSTOMER_USER.ORDER’, ’TOTAL’, ’PRETAX_TOTAL +
TAX’);

Likewise, definition component 400 saves the identified makeup fields in makeup fields table 280 in database metadata 260 (422). For example, two rows are reserved in makeup fields table 280 with the following commands:

INSERT INTO MAKEUP_FIELDS VALUES
(1, ‘CUSTOMER_USER.ORDER’ ,‘PRETAX_TOTAL’);
INSERT INTO MAKEUP_FIELDS VALUES
(2, ‘CUSTOMER_USER.ORDER’, ‘TAX’);

If there are any other derived fields in the DDL command, definition component 400 repeats steps 416-422 for each derived field (424). If there are no derived fields, or after all the derived fields have been saved to database metadata 260, definition component 400 completes normal processing of the DDL command by performing such actions as creating or altering a table in relational database such as relational database 250 (426), and stops (428).

Referring to FIG. 6, manipulation component 500 calculates derived fields in response to DML commands directed to relational database 250 such as “INSERT,” “MODIFY,” “UPDATE,” or “DELETE.” Manipulation component 500 starts when a DML command runs (510). For example, the following command could be issued by application 240:

INSERT INTO CUSTOMER_USER.ORDER
(ORDER_ID, CUSTOMER_ID, STATUS, PRETAX_TOTAL,
TAX) VALUES (123, 223, ‘OPEN’, 100.00, 6.00);

Responsive to such a command issuing from application 240, manipulation component 500 reads the manipulated fields in the DML command (512) and references the contents in derived fields table 270 and makeup fields table 280 in database metadata 260 (514). If the DML command directs updates to a derived field (516), which is prohibited, manipulation component 500 returns an error (518) and stops (536). If no derived fields (516) or no makeup fields are modified (520), manipulation component 500 completes processing of the DML command normally (534) and stops (536). If the DML command modifies a makeup field (520), manipulation component 500 saves the changes to makeup fields table 280 (522). Manipulation component 500 gathers all the corresponding makeup fields from makeup fields table 280 (524) and calculates the derived field (526). Manipulation component 500 saves the calculated value to derived fields table 270 (528). Manipulation component 500 transforms the DML command to include the updated derived field (530). For example, the above DML command issued by application 240 would be transformed to:

INSERT INTO CUSTOMER_USER.ORDER
(ORDER_ID, CUSTOMER_ID, STATUS, PRETAX_TOTAL,
TAX, TOTAL) VALUES
(123, 223, ‘OPEN’, 100.00, 6.00, 106.00);

If there are other modifications to a derived field (532), manipulation component 500 repeats steps 522-530. Once all the makeup fields and all the derived fields have been updated in derived fields table 270 and makeup fields table 280 in database metadata 260, manipulation component 500 executes the transformed DML command normally (534), updates relational database 250, and stops (536).

Because all the of DFC's 200 calculations and updates to derived fields occur in response to standard SQL commands, any application using the SQL standard can modify or query the data without running ORM tools. Moreover, the derived fields are only calculated in response to manipulations to makeup fields, rather than in response to a query, reducing the requisite overhead for applications with a high query rate.

A preferred form of the invention has been shown in the drawings and described above, but variations in the preferred form will be apparent to those skilled in the art. The preceding description is for illustration purposes only, and the invention should not be construed as limited to the specific form shown and described. The scope of the invention should be limited only by the language of the following claims.

What is claimed is:

1. A computer implemented process for calculating derived fields in a relational database, the computer implemented process comprising:
defining a derived field in a DDL command, wherein the derived field has an expression referencing a makeup field in the DDL command;
creating a relational database with the DDL command;
entering the derived field into a derived field table in the database's metadata;
entering the makeup field into a makeup field table in the database's metadata;
receiving a DML command to manipulate the makeup field in the database;
calculating the derived field using the manipulated makeup field;
updating the makeup field in the database with the value from the DML command; and
updating the derived field in the database with the calculated value.

2. The computer implemented process of claim 1 wherein the derived field has an expression referencing more than one makeup field in the DDL command.

3. The computer implemented process of claim 1 further comprising saving the value of the makeup field in the DML command to the makeup field table in the database's metadata.

4. The computer implemented process of claim 1 further comprising saving the calculated value of the derived field to the derived field table in the database's metadata.

5. The computer implemented process of claim 1 further comprising returning an error when the DML command attempts to manipulate a derived field in the relational database.

6. The computer implemented process of claim 1 further comprising modifying the DML command to include the calculated value before updating the relational database.

7. An apparatus for calculating derived fields in a relational database, the apparatus comprising:
a processor;
a memory connected to the processor;
an relational database management system (RDBMS) running in the memory;
a relational database with metadata running in the memory; and
a derived field calculator program integrated with the RDBMS application in the memory operable to define a derived field in a DDL command, wherein the derived field has an expression referencing a makeup field in the DDL command, create a relational database with the DDL command, enter the derived field into a derived field table in the database's metadata, enter the makeup field into a makeup field table in the database's metadata, receive a DML command to manipulate the makeup field in the database, calculate the derived field using the manipulated makeup field, update the makeup field in the database with the value from the DML command, and update the derived field in the database with the calculated value.

8. The apparatus of claim 7 wherein the derived field has an expression referencing more than one makeup field in the DDL command.

9. The apparatus of claim 7 wherein the derived field calculator program in the memory is further operable to save the value of the makeup field in the DML command to the makeup field table in the database's metadata.

10. The apparatus of claim 7 wherein the derived field calculator in the memory is further operable to save the calculated value of the derived field to the derived field table in the database's metadata.

11. The apparatus of claim 7 wherein the derived field calculator in the memory is further operable to return an error when the DML command attempts to manipulate a derived field in the relational database.

12. The apparatus of claim 7 wherein the derived field calculator in the memory is further operable to modify the DML command to include the calculated value before updating the relational database.

13. A computer readable memory containing a plurality of instructions to cause a computer to calculate derived fields in a relational database the plurality of instructions comprising:
a first instruction to define a derived field within a DDL command, wherein the derived field has an expression referencing a makeup field in the DDL command;
a second instruction to create a relational database with the DDL command;
a third instruction to enter the derived field into a derived field table in the database's metadata;
a fourth instruction to enter the makeup field into a makeup field table in the database's metadata;
a fifth instruction to receive a DML command to manipulate the makeup field in the database;
a sixth instruction calculate the derived field using the manipulated makeup field;
a seventh instruction to update the makeup field in the database with the value from the DML command; and
an eighth instruction to update the derived field in the database with the calculated value.

14. The computer readable memory of claim 13 wherein the derived field has an expression referencing more than one makeup field in the DDL command.

15. The computer readable memory of claim 13 comprising an additional instruction to save the value of the makeup field in the DML command to the makeup field table in the database's metadata.

16. The computer readable memory of claim 13 comprising an additional instruction to save the calculated value of the derived field to the derived field table in the database's metadata.

17. The computer readable memory of claim 13 comprising an additional instruction to return an error when the DML command attempts to manipulate a derived field in the relational database.

18. The computer readable memory of claim 13 comprising an additional instruction to modify the DML command to include the calculated value before updating the relational database.
